(19) United States
(12) Patent Application Publication
(10) Pub. No.: US 2006/0080710 A1
(43) Pub. Date: Apr. 13, 2006

(54) (Internet multimedia) Taylor made TV channel navigation system

(76) Inventor: Taylor Christopher Carthern, Atlanta, GA (US)

Correspondence Address: Taylor Carthern, 110 Old Fairburn Close, Atlanta, GA, 30331, US

(21) Appl. No.: 10/945,107

(22) Filed: Sep. 20, 2004

(51) Int. Cl. H04N 5/445

(52) U.S. Cl. 725/47

(57) ABSTRACT

Web TV Channel Navigation System will be set up using an alphanumeric system. C101 would be a church site and F101 would be a favorite site. The remote control would have letters and numbers for easy navigation to the internet site. This will be used for TV viewing and streaming video. Our Internet receiver will be connected to the user's television and the remote would be used to input the alphanumeric code for a particular website. A new movie preview system in which we would operate in a physical location. Set up our screen connected to our site at the location of the store in the video sections. The buyer will preview movies and decide if they want to rent or buy movies instead of reading the back the movie. System will be implemented at Blockbusters, Movie Gallery's, Wal-Mart's and etc. Use a universal remote control that will also be used as a cordless telephone. The remote/telephone will have a base charger that you will plug into the wall. You can use the phone while you are connected to the network or even when you are not connected to the network. The phone will have caller id. Benefits of watching the internet using a remote control instead of a mouse and keyboard: watch WebTV like watching satellite. Remote will allow you to replay highlights for programs. Using our internet box program, you will be able to convert your TV into a computer creating more viewers watching internet TV programs.

### BACKGROUND-FIELD OF INVENTION

This present invention relates to having a box similar to a satellite box that you would hook up to your television that would be used with your interest without your keyboard. You would use your remote control and Software program based on an alphanumeric system.

### BACKGROUND IF INVENTION

U.S. Pat. No. 6,769,018 A system for quickly and easily accessing or URLs on the internet is disclosed in which a unique jump code for a particular desired address is published by printing it in an advertisement in a Yellow Pages directory or in a newspaper advertisement or by announcing it during a television or radio program. The user enters the jump code into an internet location for receiving it, e.g., the home page of the Yellow Pages publisher, to access the desired address without typing the full URL. The user can then receive more information, promotional coupons, or the like. The jump code uses a numeric system and only works with advertisements.

The last year of the 20^{th} century marked the beginning of the broadband and streaming media frenzy. Streaming media allows multimedia content to be played on computers as it is being received, rather waiting until the entire file is downloaded. Media that can be streamed include synchronized graphics, text, sound, video, 3d images, music and virtual reality environment.

There is a need for an invention that can connect users to internet websites by using a remote to turn to predetermined channels that would convert into websites. There are issues with consumer habits and interface problems and ease of use. Taylor Made TV Navigation system will solve this problem by setting up a system that operates with a remote control that have letters and numbers channels setup like cable and satellite TV.

### DESCRIPTION OF RELATED INVENTIONS

The use of the Internet is a major communications business between businesses, corporations, government, universities and many individual users around the globe. The Internet is a network or networks connected by physical and satellite data links. The Internet was developed in the late 1960's: for the United States Defense Department as a research project for use by defense contractors and universities. The Internet was primarily used for research purposes for universities, governments, and organizations in science and academia. The Internet has grown slowly, but now it has reached new levels. In 1992, the United States Government turned over operation of the Internet's high-speed data links to commercial networks. After this transfer, with the explosion of personal computers, local area networks, and consumer-oriented online services, it caused the Internet to grow rapidly. The web is a method of combining the display of text, audio and video clips, and graphics including secure credit card transactions, into a friendly interface that is easy to use. The web was designed for researches to easily publish scientific documents online. Creation of the first point and click program for browsing the web was created in early 1990's. Shortly after that commercial companies like Netscape developed more web browsers. Other major web browsers include AOL and MSN. The World Wide Web consists uses the new broadcast, which provides individuals, groups, and companies with new opportunities for communication. It is even easy to create one's own website or address on the web that millions of users are able to reach. The Internet provides an outlet for anyone who wants to self publish graphics, video and audio clips.

There is so much multimedia potential on the web that any web browser can access. Browsers also have the feature of book marking favorites, which allows the user to save any website that they have visited and can be revisited without typing in the address. Via the web, users can instantly access many types of information, entertainment and interactive resources. The resources on the web are reached by millions of users and the potential is limitless. A web browser is a graphical Windows based software program that is used on a person computer to access the Internet. A web site is a collection of files located under a directory that has graphics, pictures, texts, video and audio clips. There is a similar invention that utilizes web sites that is an online publication containing descriptions of selected web sites or addresses together with jump codes, which uses the inputted jump code to access the desired website. The jump code is only used for advertisements. The jump code consists of a four-digit code only using numbers. It is based on a numeric system. All web sites are given a jump code that the users input to access this website. The user accesses the specialized website using the TV Internet Terminal and then enters a jump code using a remote control. The TV Internet Terminal will be connected to the television terminal. One example is a localized printed Yellow Pages telephone directory published in a localized metropolitan area, in which the predetermined jump code is published within a printed display ad in the localized Yellow Pages for a metro area It is also used in newspaper ads and would be published in a text classified ad like “Real Estate” or “Help Wanted”.

### OBJECTS AND ADVANTAGES

Several of the advantages of my invention include:
(a) Our Taylor Made Network is based on an alphanumeric combination.
(b) Taylor Made site software program will convert web addresses to letters and numbers (alphanumeric combination) easily used by remote control;
(c) The remote control would have letters and numbers (alphanumeric combination) for easy navigation to the Internet site.
(d) Viewing streaming media as a satellite TV with remote control and internet receiver similar to satellite box hooked up to television.
(e) It makes using a computer easy to use.
(f) A network guide similar to the TV guide will be used for easy navigation of the network.
(g) The setup of the guide will help people find their channels easier. Example Favorites will be “F” 1-100.
(h) Favorite channel will be set for quick and easy guide.
(i) Our universal remote phone will be used for both the television and talking on the phone.
(j) People will be able to view high school sports games and also news.
(k) Our system does not need a keyboard.
(l) You can watch Internet TV like satellite or cable using streaming media.
(m) Our Internet receiver program will convert your TV into computer creating more viewers watching Internet TV programs.

### REFERENCING NUMERALS IN DRAWINGS

10 sliding door for mini keyboard.

### SUMMARY OF INVENTION

Statistics show that more people stay on streaming video sites longer than the normal sites. The program will operate on an internet receiver similar to a satellite box that connects to the internet. We will have a TV guide on the program that connects to the network via TV. We would use a universal remote similar to a satellite TV remote. Taylor Made Network will also work for streaming media as well as text. ex. You can email your friend or read the text on a website. The users would be able to set their own favorites on the remote control. The codes that we change the websites into, using the Taylor Made Network Software program, will be using symbols and alphanumeric combinations. We would use a software program that converts the websites into the combinations and we would have a TV guide listing with all the channels for the users. Some codes will begin with ga if the users are in Georgia and with the name of the state that they live in. There will be a listing that helps the users know what combination everyone needs to input on the remote control. The remote control will pull out into a mini keyboard where the user can type in the name of a website or type in information. We will use our receiver box to display video on broadband with our software program.

### BRIEF DESCRIPTION OF DRAWINGS

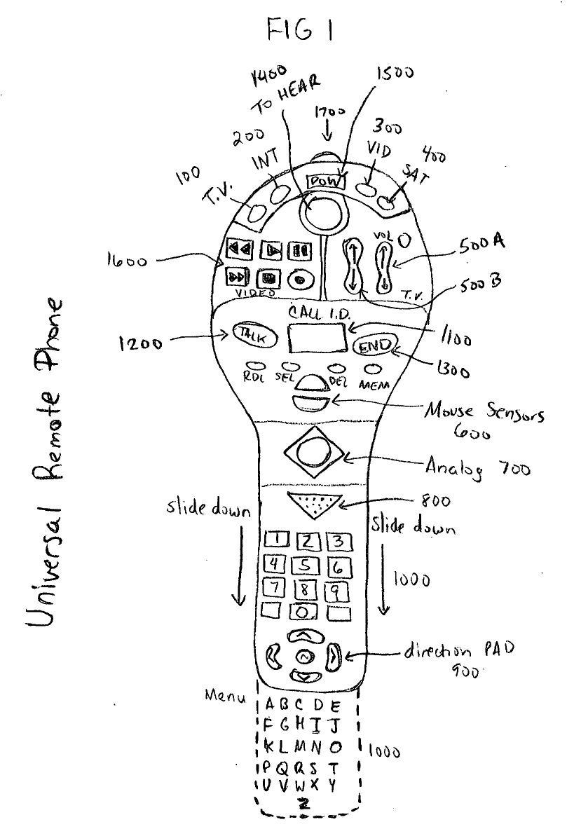

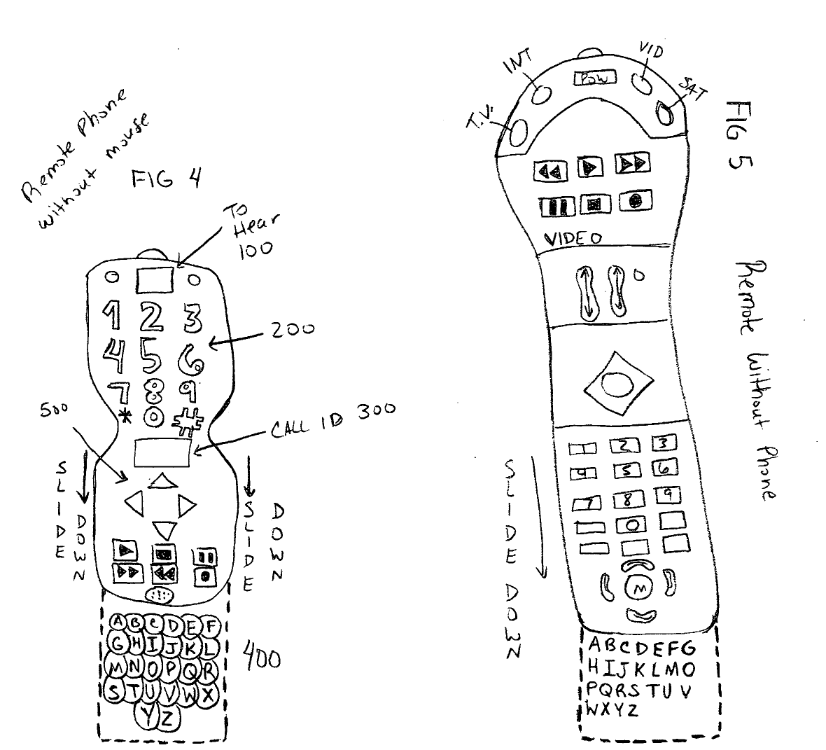

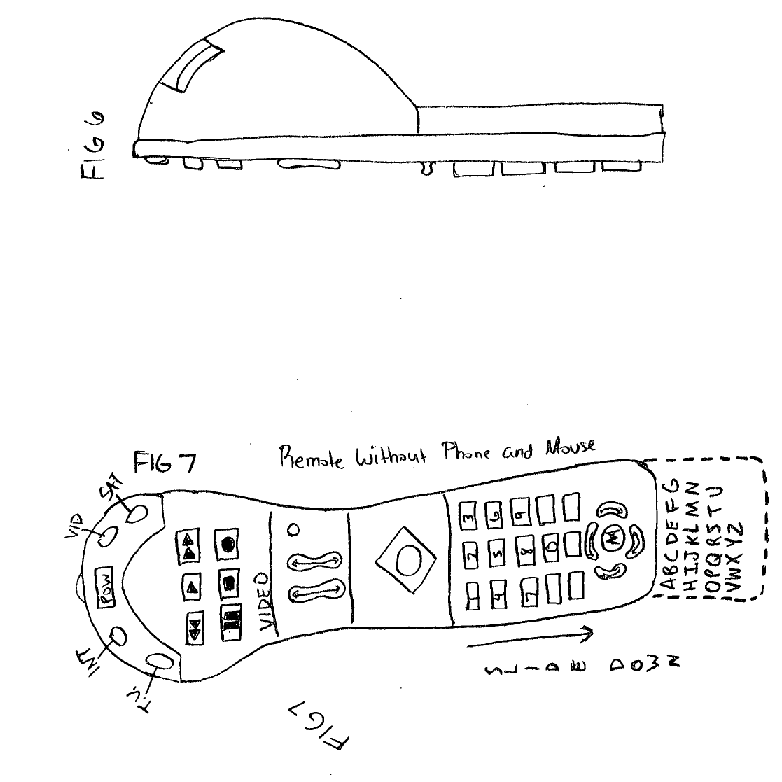

FIG. 1 displays the universal remote phone. FIG. 1-100 is the button for changing the setting to television. FIG. 1-200 is the button for changing the setting to the internet and FIG. 1-300 is used for video and FIG. 1-400 will be the button used for the satellite setting. FIG. 1-500A will be used for turning the volume up and down on the television or computer and FIG. 1-500B will be used for turning the channels up and down on the television and computer. FIG. 1-600 is displayed as the mouse sensors. FIG. 1-700 is the analog controller used for navigating the television or computer screen. FIG. 1-800 represents where you would speak into when using the telephone. FIG. 1-900 will be used to access the menu and also to navigate the television and computer screens. FIG. 1-1000 represents the mini keyboard as it is pulled out from the remote control and used to type in websites or channels that you want to look at. FIG. 1-1100 is the caller id block on the Universal Remote Phone. FIG. 1-1200 represents the talk button that establishes the dial tone on the telephone line and FIG. 1-1300 represents the End button that will be used to hang up the telephone. FIG. 1-1400 represents the receiver that you will hold your ear to in order to listen to the person that has called you or you called. FIG. 1-1500 displays the pow button which is short for power which turns on the satellite, television, internet connection, and video. FIG. 1-1600 represents the control for watching a movie or video. You would use these controls to play, rewind, fast forward, stop, or to pause the movie. FIG. 1-1700 displays the sensor that reads into the cable box on top of the computer or television.

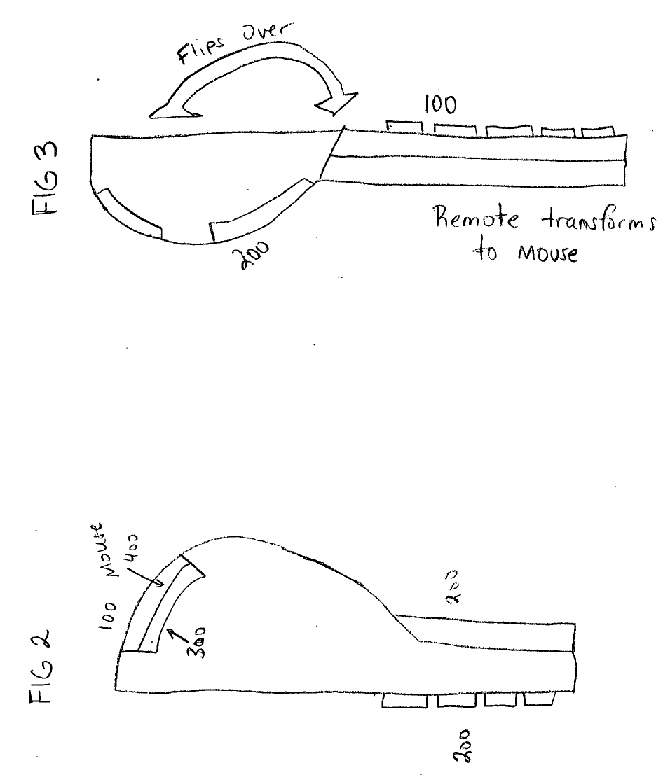

FIG. 2 displays the other side of the Universal remote phone that shows the mouse control. FIG. 2-100 represents the mouse on the other side of the remote phone when it is flipped over. FIG. 2-200 represents the other side of the remote, opposite the mouse, that is used for the phone and navigating the network. FIG. 2-300 displays the left-click of the mouse and FIG. 2-400 represents the right-click of the mouse control.

FIG. 3 represents the universal remote phone as the side view. This way you can view both sides and see how one side is for the mouse: and the other for the remote and telephone. FIG. 3-100 displays the buttons on the telephone and remote on one side while FIG. 3-200 represents the mouse right-click and left-click on the other side of the remote phone. The picture shows the remote changing into a mouse.

FIG. 4 represents the universal remote phone from the front. This way you can see the remote without the mouse. This remote is made without the mouse. FIG. 4-100 displays where you would put your ear to the phone receiver to hear the person you are talking to.

FIG. 4-200 represents the number pad used for dialing numbers and entering the alphanumeric combinations. FIG. 4-300 represents where the phone will have caller id. FIG. 4400 is the mini keyboard that pulls out and allows you to type in the alphanumeric combination with the number pad. FIG. 4-500 represents the control pad used to change the channels on the television by using the internet receiver.

FIG. 5 represents the universal remote for the Taylor Made receiver without the phone capability. This remote has all the same functions of the universal remote phone except for operating as a telephone.

FIG. 6 represents the universal remote at a side view that shows the mouse clicks.

FIG. 7 represents the universal remote without the phone and the mouse. It operates the same as the universal remote phone, except it does not operate as a phone or a mouse.

### DETAILED DESCRIPTIONS OF DRAWINGS

Web TV Channel Navigation System will be set up using an alphanumeric system. Ex. C101 would be a church site and F101 would be a favorite site. Taylor Made TV Network Software Program will convert web addresses to letters and numbers easily used by remote control. The remote control would have letters and numbers for easy navigation to the internet site. This will be used for TV viewing and streaming video. Our Internet receiver will be connected to the user's television and the remote would be used to input the alphanumeric code for a particular website. If you are connected to the Internet on the computer, you will not need the box, it is only for the receiver hooked up to the television.
Our network will use streaming media applications span from sporting events, concert tours, movie clips, interactive chats, multimedia presentations, advertising, video conferencing, training sessions, corporate information, education, newscast, and live event broadcasting, etc. Applications will be live or on demand. Also including, but not limited to, corporate communication, commercial broadcasting, digital entertainment, and distance learning. With lower costs and worldwide coverage, live events broadcasting over the Internet had gained popularity. Trade shows, conferences, fashion premieres, and even live baby delivery have been shown on the Internet. Streaming media will allow us to distribute music, movie, and other entertainment packages in enjoyable ways. The popularity of distance learning continuously rising. We can make it more comfortable without the use of a keyboard. The spread of broadband access will make online learning better with graphics and high quality video. We will also webcast radio and radio stations on our Internet channels. All radio stations will have an alphanumeric code that you would press with the remote phone and it would take you to whatever station you want to listen to. Music downloads will be easier with our navigation system. If a television company would like to make the television with our software embedded in it, where there is no need for the internet receiver. They would have to use our universal remote control and our software to use these televisions. We would do that for them.
We will be introducing a new movie preview system in which we would operate in a physical location. We would set up our screen connected to our site at the location of the store in the video sections. The buyer will be able to preview movies and decide if they want to rent or buy movies instead of reading the back the movie. Our system will be implemented at Blockbusters, Movie Gallery's, Wal-Mart's and etc. You will be able to select a movie and watch the preview. Our video promotion screen will be used for promoting new movies. This works exceptionally well for videos people know very little about. This concept is great for new movies that are sold at Video Rental stores. Ex. This is like when you go into a video store to buy a music cd, they have little stations with headphones where you can preview the cd and then decide if you want to purchase it. By the viewers watching our screen to preview the movie of their choice, they will be able to decide if the would like to purchase the movie. Our website will preview movies OnDemad. This will enable customers to access or TV screen also on their mobile phone or any other object that you will be able to see streaming video on. We are also bringing the real intensity of sports experiences to worldwide audiences we would use digital sports companies to create channels on our network that would make sports programs available at the click of the remote phone. We would also include some travel networks that would bring attractions to you via streaming media. You can push the alphanumeric code on the remote a visit a place that you would like to visit at home. You will be able to view upcoming events, vacation specials, and travel packages. Also we will have channels where if you are searching for a home, will be able to view homes online via streaming media and decide if you like without even stepping foot out of your bed or off your sofa.
Taylor Made TV network will convert sites into easy to remember alphanumeric codes with a WebTV Guide for each category similar to a TV Guide. For example, church ministries would be “C” 1-100, and favorites would be “F” 1-100 etc.
The Taylor Made Network will use a universal remote control that will also be used as a cordless telephone. The remote/telephone will have a base charger that you will plug into the wall. You can use the phone while you are connected to the network or even when you are not connected to the network. The remote control will pull out into a mini keyboard and on the other side will be a wireless mouse with left and right click. One side of the remote will be for the mouse and the other side of the remote will be used for calling turning channels and watching media. The phone will have caller id.
Channels that will be available include but not limited to:
High school sports, black college sports, gospel music, church ministries, fitness, shopping, seminars ex. Real Estate, motivation, Travel/Vacation, Kids, cartoons, videos, news, video games, movies, college news, conventions, music videos and songs.
WebTV today is not used properly or up to its capability. When using a computer, you would have to use a keyboard or mouse to control the WebTV system. Making the system limited and uncomfortable for the common TV watcher who is use to using a remote control. Taylor Made TV Network will turn the streaming video into a system operation like satellite or cable navigated by a remote control instead of a keyboard or mouse controlled with an alphanumeric system. Taylor Made Network will also work for streaming media as well as text. Ex. You can email your friend or read the text on a website.
Benefits of watching the internet using a remote control instead of a mouse and keyboard: You can watch WebTV like watching satellite or cable. Remote will allow you to replay highlights for programs. Ability to watch OnDemand programs. By using our internet box program, you will be able to convert your TV into a computer creating more viewers watching internet TV programs.
The internet receiver will take internet viewing to the next level. It will also create more viewers and advertisers, creating more revenue to develop more programs.

### OPERATION OF INVENTION

The invention includes some primary parts, the universal remote phone and the Internet connection receiver. The internet receiver is similar to the box that is used for the satellite television. The box will translate the channels into the websites. Taylor Made network software program will convert sites into alphanumeric codes that would be used to identify the channels. These codes will be used for input with the remote control. The universal remote phone will be used as a remote, mini keyboard, a wireless mouse, and a cordless telephone.

### SUMMARY

Web TV Channel Navigation System will be set up using an alphanumeric system. The Internet receiver will hook up to your television and the remote phone will control the channels that you view. Ex. C101 would be a church site and F101 would be a favorite site. Taylor Made TV site will convert web addresses to letters and numbers easily used by remote control. The remote control would have letters and numbers for easy navigation to the internet site. This will be used for TV viewing and streaming video. The users would be able to set their own favorites on the remote control. The codes that we change the websites into will be using symbols and alphanumeric combinations. We would use a software program that converts the websites into the combinations and we would have a TV guide listing with all the channels for the users. Some codes will begin with ga if the users are in Georgia and with the name of the state that they live in. There will be a listing that helps the users know what combination everyone needs to input on the remote control. Channels that will be available include but not limited to: High school sports, black college sports, gospel music, church ministries, fitness, shopping, seminars ex. Real Estate, motivation, Travel/Vacation, Kids, cartoons, videos, news, video games, movies, college news, conventions, music videos and songs.

What I claim as my invention is:

1. An apparatus Internet receiver similar to the satellite box that will be hooked up to the television that will transmit the connection to our Taylor Made TV Network.

2. A remote control that will be used to change the channels to different web sites.

3. A remote control of claim 2 that will be used for television, the internet receiver and will also be a wireless mouse.

4. A remote control of claim 2 that will be used for the television, the internet receiver that will not be a mouse.

5. A remote control of claim 2 that will be used for television, the internet receiver that will not be a mouse, that pulls out into a mini keyboard.

6. A remote control of claim 2 and 3 that pulls out into a mini keyboard.

7. A remote control of claim 2 and 3 that also is used as a telephone with caller id.

8. A remote control of claim 2 and 3 that also is used as a telephone without caller id.

9. A remote control of claim 2 and 3 that is not used as a telephone.

10. A remote control of claim 2 that is not used as a telephone.

11. A remote control of claim 2 that is not pulls out into a mini keyboard.

12. An alphanumeric combination that will be used to translate the web sites that users are trying to access into channels including:
The method of claim 12 where the alphanumeric combination will represent high school sports channel ex. HS 1-100.
The method of claim 12 where the alphanumeric combination will represent black college sports channels ex. BS 1-100.
The method of claim 12 where the alphanumeric combination will represent gospel music channels ex. GM 1-100.
The method of claim 12 where the alphanumeric combination will represent church ministries channels ex. C 1-100.
The method of claim 12 where the alphanumeric combination will represent fitness channels ex FTN 1-100.
The method of claim 12 where the alphanumeric combination will represent shopping channels ex SH 1-100.
The method of claim 12 where the alphanumeric combination will represent seminar or real estate channels ex RE 1-100 or SM 1-100.
The method of claim 12 where the alphanumeric combination will represent motivational channels ex. MT 1-100.
The method of claim 12 where the alphanumeric combination will represent travel or vacation channels ex. TRV 1-100.
The method of claim 12 where the alphanumeric combination will represent kids channels ex KID 1-100.
The method of claim 12 where the alphanumeric combination will represent cartoon channels ex CAR 1-100.
The method of claim 12 where the alphanumeric combination will represent music video channels ex MV 1-100.
The method of claim 12 where the alphanumeric combination will represent radio station channels ex. RS 1-100.
The method of claim 12 where the alphanumeric combination will represent news channels ex. NE 1-100.
The method of claim 12 where the alphanumeric combination will represent video games channels ex. VG 1-100.
The method of claim 12 where the alphanumeric combination will represent a TV guide channel for the sites with the corresponding alphanumeric combinations ex. TV 1-100.
The method of claim 12 where the alphanumeric combination will represent movie channels ex. MOV 1-100.
The method of claim 12 where the alphanumeric combination will represent college news channels ex. CN 1-100.
The method of claim 12 where the alphanumeric combination will represent convention channels ex. CON 1-100.
The method of claim 12 where the alphanumeric combination will represent favorite channels ex. F 1-100.
The method of claim 12 where the alphanumeric combination will represent advertisement channels ex. AD 1-100.

13. The method of making a TV screen that is connected to our web site that will preview movies.

14. The method of claim 13, previewing movies using a TV screen to determine if you want to buy, order or rent that movie.

15. The method of claim 13, to put our screen in stores (physical locations) such as Wal-Mart, Blockbuster, Movie Gallery, Best Buy and others stores that will be connected to our web site. The customers will preview the movies in the store in order to decide if they want to buy or rent the movie.

16. The method of claim 13, to put our Taylor Made TV screens into any physical location and store for the purpose of previewing movies.

17. The method of claim 1, where the internet receiver will display websites via the television with streaming media, graphics and text.

18. The method of claim 1, where a TV company will make televisions already with the receiver imbedded in it, where there is no need for the outside receiver.

19. A method of providing access to preselected locations on the Internet, translated into the alphanumeric combinations:
By publishing a TV Guide for the web sites for the Taylor Made TV Network. Publishing the alphanumeric combinations corresponding to the predetermined websites.
Providing a predetermined Internet location, comprising means for translating into an alphanumeric code assigned to a desired preselected Internet location.
The user enters the alphanumeric code that is translated by the Taylor Made Software on the remote to go to the predetermined location.
The user enters the alphanumeric code on the remote phone to go to the predetermined location.
Our software program that converts the alphanumeric code to a URL address representing the predetermined location on the Internet.

20. The method of claim 13 where we put our Taylor Made TV screen into stores for the purpose of viewers previewing movies before they rent, buy, or purchase a movie.

21. A method of providing access to preselected locations on the Internet, translated into the alphanumeric combinations:
By publishing a TV Guide for the web sites for the Taylor Made TV Network. Publishing the alphanumeric combinations corresponding to the predetermined URL address.
Providing a predetermined Internet location, comprising means for translating into an alphanumeric code assigned to a desired preselected Internet location.
The user enters the alphanumeric code on the remote phone to go to the predetermined location
The user enters the alphanumeric code that is translated by the Taylor Made Software on the remote to go to the predetermined location.
Our Taylor Made Network Software will convert the alphanumeric code to a URL address representing the predetermined location on the Internet.

22. A method of providing access to preselected locations on the Internet, translated into the alphanumeric combinations:
By publishing a TV Guide for the web sites for the Taylor Made TV Network. Publishing the TV Guide with the alphanumeric combinations for the preselected Internet locations. Providing a predetermined Internet location, comprising means for translating into an alphanumeric code assigned to a desired preselected Internet location. The user enters the alphanumeric code on the remote phone to go to the predetermined location. Converting the alphanumeric code to a URL address representing the predetermined location on the Internet. The user enters the alphanumeric code that is translated by the Taylor Made Software on the remote to go to the predetermined location. Our Taylor Made Network Software will convert the alphanumeric code to a URL address representing the predetermined location on the Internet.

23. A method of translating the websites into alphanumeric combinations using our Taylor Made Network Software program.

24. The method of claim 1 of already creating televisions with the internet receiver already in the televisions, and the use of the universal remote, thus creating no need for the internet receiver on top of the television.
